(19) United States
(12) Patent Application Publication
(10) Pub. No.: US 2016/0268650 A1
(43) Pub. Date: Sep. 15, 2016

(54) BATTERY PACK

(71) Applicant: Samsung SDI Co., LTD., Yongin-si (KR)

(72) Inventor: Sangdo Heo, Yongin-si (KR)

(21) Appl. No.: 14/838,763

(22) Filed: Aug. 28, 2015

(30) Foreign Application Priority Data
Mar. 11, 2015 (KR) 10-2015-0033788

(51) Int. Cl. H01M 10/46; H02J 7/00

(52) U.S. Cl. CPC H01M 10/46; H02J 7/007

(57) ABSTRACT

A battery pack is disclosed. In one aspect, the battery pack includes a secondary battery including at least a pair of electrode tabs and a circuit board accommodating at least one circuit configured to control at least one of charging and discharging operations of the secondary battery. The battery pack also includes at least a pair of tab fixing clips placed at the circuit board and configured to fix each of the electrode tabs. Each tab fixing clip includes a bending portion including first and second ends opposing each other and first and second portions respectively extending from the first and second ends of the bending portion and at least partially overlapping each other in the depth dimension of the secondary battery. At least part of the corresponding electrode tab is interposed between and contacted by the first and second portions.

### INCORPORATION BY REFERENCE TO ANY PRIORITY APPLICATIONS

This application claims priority to and the benefit of Korean Patent Application No. 10-2015-0033788, filed on Mar. 11, 2015, in the Korean Intellectual Property Office, the entire content of which is incorporated herein by reference in its entirety.

This application relates to U.S. patent application entitled “BATTERY PACK” (Attorney docket: SDISHN.350AUS, application Ser. No. ______), which is concurrently filed on the same date as this application and incorporated herein by reference in their entirety.

### BACKGROUND

1. Field

The described technology generally relates to a battery pack

2. Description of the Related Technology

A secondary battery (or rechargeable battery) can be repeatedly used as it can be charged and discharged multiple times. The charging source can be via conventional power such as a power plant on a grid or localized solar energy or other renewable energy source. Such secondary battery can be used as the energy source for not only electronic devices such as a mobile phone, a laptop or tablet computer and a camcorder, but also for automobiles and power generation storage.

Depending on commercial applications, in order to implement a large output or high capacity secondary battery, a number of unit battery cells are arranged in series or in parallel. Also, based on need, a secondary battery can be augmented with a controller that controls charge or discharge of the secondary battery and prevents overcharge or overdischarge of the secondary battery.

### SUMMARY OF CERTAIN INVENTIVE ASPECTS

One inventive aspect relates to a battery pack including a secondary battery.

Another aspect is a battery pack that does not require welding when coupling a secondary battery to a circuit board.

Another aspect is a battery pack that is compact and has good durability may be provided.

Another aspect is a battery pack including a secondary battery including a secondary battery including at least a pair of electrode tabs, a circuit board where at least one device in a circuit controlling at least one of charge or discharge of the secondary battery is mounted and at least a pair of tab fixing clips included at the circuit board and fixing each of the at least a pair of electrode tabs, wherein each of the at least a pair of tab fixing clips includes a first portion fixed to the circuit board and a second portion extending by being bent at the first portion and applying pressure on the electrode tabs located between the first portion and the second portion, the second portion having hole.

The second portion, as a shape of the hole changes, may fix the electrode tabs by applying pressure.

Each of the at least a pair of tab fixing clips further includes a clip wing extending to the circuit board from the second portion, being bent and being fixed to the circuit board.

The clip wing may extend to an opposite surface of a surface of the circuit board to where the second portion is fixed.

The circuit board may include an incision portion where the clip wing passes.

The incision portion may be formed adjacent to the boundary of the first portion.

The first portion may include a groove at a location corresponding to the incision portion.

The circuit board may include a clip fixing surface on which the at least a pair of tab fixing clips are fixed, wherein the at least a pair of electrode tabs extends towards an outer side of the secondary battery on an opposing surface of the clip fixing surface and extends towards the secondary battery on the clip fixing surface.

The circuit board may be bent thereby a pair of inner surfaces facing each other, wherein the clip fixing surface is one of the pair of inner surfaces.

The battery pack may further include an insulating substrate between the pair of inner surfaces and supporting the circuit board.

The electrode tabs may be inserted between the first portion and the second portion through the hole.

The electrode tabs may be inserted into a gap between the first portion and the second portion.

Another aspect is a battery pack comprising: a secondary battery including at least a pair of electrode tabs; a circuit board accommodating at least one circuit configured to control at least one of charging and discharging operations of the secondary battery; and at least a pair of tab fixing clips placed at the circuit board and configured to fix each of the electrode tabs, wherein each tab fixing clip includes: a bending portion including first and second ends opposing each other; and first and second portions respectively extending from the first and second ends of the bending portion and at least partially overlapping each other in the depth dimension of the secondary battery, wherein the bending portion is bent with respect to at least one of the first and second portions, and wherein at least part of the corresponding electrode tab is interposed between and contacted by the first and second portions.

In the above battery pack, the second portion is configured to fix the electrode tab based on pressure applied thereto. In the above battery pack, each of the tab fixing clips further comprises a clip wing extending toward the circuit board from the second portion, being bent and being fixed to the circuit board. In the above battery pack, the clip wing extends to an opposite surface of a surface of the circuit board to which the second portion is fixed. In the above battery pack, the circuit board has an incision portion formed therein through which the clip wing passes. In the above battery pack, the incision portion is formed adjacent to a boundary of the first portion. In the above battery pack, the first portion includes a groove at a location corresponding to the incision portion. In the above battery pack, the circuit board includes a clip fixing surface on which the tab fixing clips are fixed, wherein the electrode tabs extend towards an outer side of the secondary battery at an opposing surface of the clip fixing surface and extend towards the secondary battery at the clip fixing surface.

In the above battery pack, the circuit board is bent such that a pair of inner surfaces face each other, and wherein the clip fixing surface is one of the pair of inner surfaces. The above battery pack further comprises an insulating substrate interposed between the pair of inner surfaces and supporting the circuit board. In the above battery pack, the second portion has a hole. In the above battery pack, each electrode tab includes an inserted portion that is inserted into the hole and interposed between and contacted by the first and second portions. In the above battery pack, each electrode tab includes a non-inserted portion that is not inserted into the hole and contacts the second portion. In the above battery pack, the non-inserted portion non-linearly extends from the inserted portion. In the above battery pack, the electrode tabs are inserted into a gap between the first portion and the second portion. In the above battery pack, the second portion is configured to press the corresponding electrode tab against the first portion.

Another aspect is a battery pack comprising: a secondary battery including at least a pair of electrode tabs; a circuit board accommodating at least one circuit configured to control at least one of charging and discharging operations of the secondary battery; and at least a pair of tab fixing clips placed at the circuit board and fixing each of the electrode tabs, wherein each tab fixing clip includes: an intermediate portion including first and second ends opposing each other; upper and lower portions respectively extending from the first and second ends of the intermediate portion and at least partially overlapping each other in the depth dimension of the secondary battery, wherein the upper portion has a hole into which at least part of the corresponding electrode tab is inserted, interposed between and contacted by the first and second portions.

In the above battery pack, each electrode tab includes a non-inserted portion that is not inserted into the hole and contacts the upper portion. In the above battery pack, the non-inserted portion non-linearly extends from the inserted portion of the electrode tab. In the above battery pack, the upper portion is configured to fix the electrode tab based on pressure applied thereto.

### BRIEF DESCRIPTION OF THE DRAWINGS

FIG. 1 is a perspective view of a battery pack according to an embodiment.

FIG. 2 is an exploded perspective view of the battery pack shown in FIG. 1.

FIG. 3 is a cross-sectional view of the battery pack seen in the I-I′ direction of FIG. 1.

FIG. 4 is a perspective view of a clip fixing surface facing upwards in a state before a circuit board is folded in the battery pack shown in FIG. 1.

FIG. 5 is a perspective view of a device fixing surface of the circuit board shown in FIG. 4 facing upwards.

FIG. 6 is a perspective view of an electrode tab of the secondary battery being connected to a circuit board through a tab fixing clip of the circuit board shown in FIG. 4.

FIG. 7 is a perspective view of a secondary battery of the battery pack shown in FIG. 1.

FIG. 8 is an exploded perspective view of the secondary battery shown in FIG. 7.

FIG. 9 is a perspective view of an electrode tab of the secondary battery shown in FIG. 7 being inserted in a tab fixing clip of the circuit board shown in FIG. 4.

FIG. 10 is a cross-sectional view illustrating a pressurization direction of a tab fixing clip as an arrow, seen in the II-IP direction of FIG. 9.

FIG. 11 is a perspective view of a circuit board being folded in a direction of arrow 1.

FIG. 12 is a perspective view of a pair of electrode tabs being folded in a direction of arrow 2 in FIG. 11.

FIG. 13 is a perspective view of a tab fixing clip being applied to the circuit board in FIG. 4 according to another embodiment.

FIG. 14 is a side cross-sectional view of a tab fixing clip shown in FIG. 13 being pressurized and fixing a pair of electrode tabs according to one embodiment.

FIG. 15 is a perspective view a tab fixing clip being applied to the circuit board of FIG. 4 according to another embodiment.

FIG. 16 is a perspective view illustrating a state in which a tab fixing clip into which a pair of electrode tabs are inserted as shown in FIG. 15 is pressurized first.

FIG. 17 is a perspective view of a clip wing of the tab fixing clip shown in FIG. 16 being bent and fixed to a circuit board.

FIG. 18 is a perspective view of a tab fixing clip being applied to the circuit board in FIG. 4 according to another embodiment.

FIG. 19 is a cross-sectional view illustrating a state in which a tab fixing clip in FIG. 18 is pressurized and fixes a pair of electrode tabs, seen in the direction of FIG. 18.

FIG. 20 is a cross-sectional view illustrating a state in which a tab fixing clip in FIG. 18 is pressurized and fixes a pair of electrode tabs, seen in the IV-IV′ direction of FIG. 18.

### DETAILED DESCRIPTION OF CERTAIN INVENTIVE EMBODIMENTS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout. In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, it will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In this disclosure, the term “substantially” includes the meanings of completely, almost completely or to any significant degree under some applications and in accordance with those skilled in the art. Moreover, “formed on” can also mean “formed over.” The term “connected” includes an electrical connection.

The secondary battery described herein may be any type of battery which may be charged and discharged multiple times.

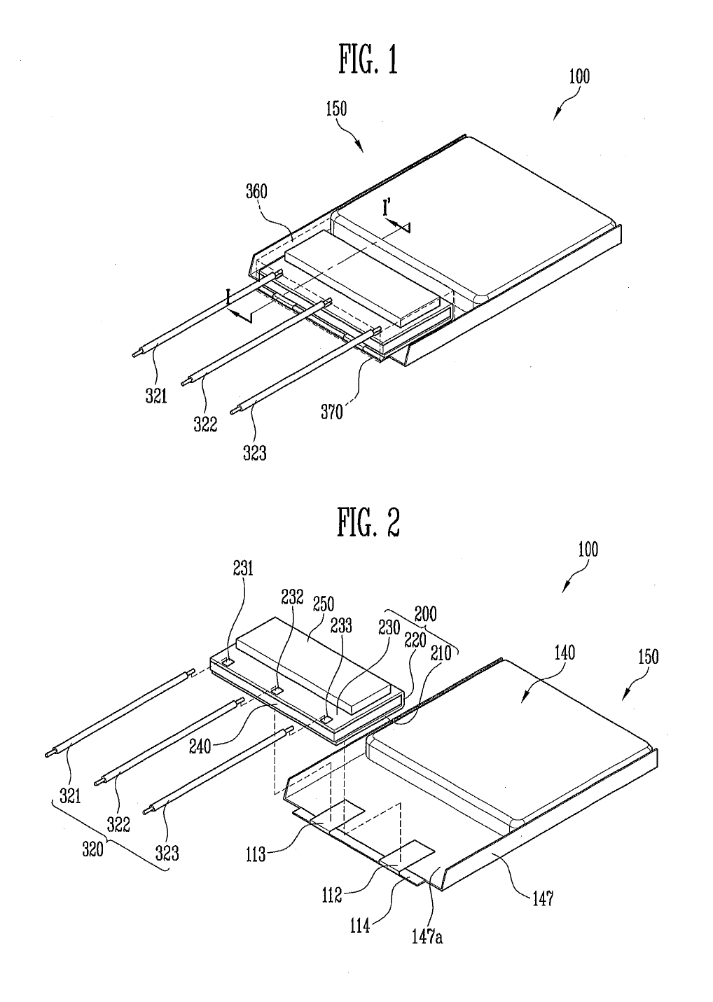

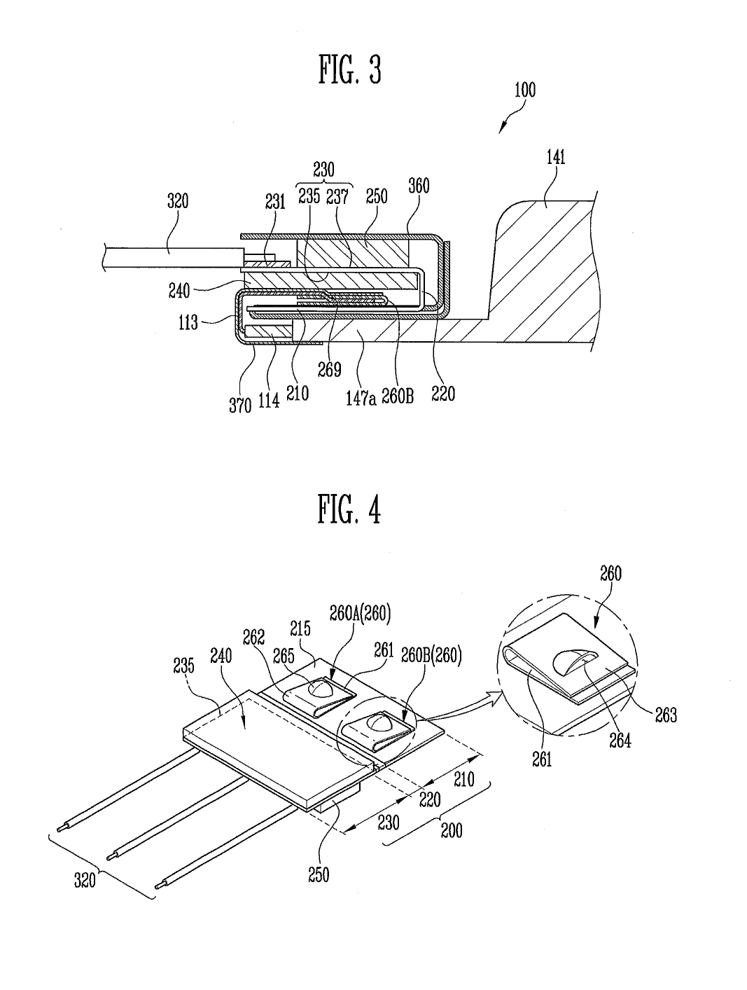

Referring to FIGS. 1 and 2, a battery pack 100 includes i) a secondary battery 150 including a pair of electrode tabs, ii) a circuit board 200 electrically connected to the secondary battery 150 and where a device, and the like, are mounted, iii) an insulating plate 240 and iv) a plurality of insulating tapes 360 and 370.

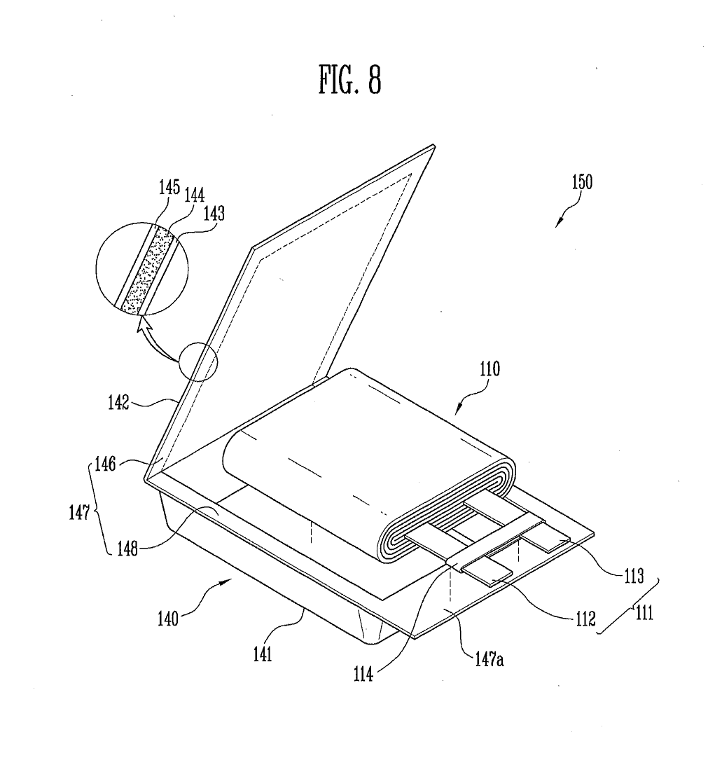

The secondary battery 150 may include an electrode assembly with a separator interposed between a pair of electrodes and an electrolyte, the electrode assembly and the electrolyte being sealed in a battery case. The pair of electrodes may have different polarities, one of them being an anode and the other being an anode. The electrode assembly may be formed by the anode, the separator and the cathode being stacked (stack type) or by being winded after being stacked (wind type). The structure of the secondary battery 150 will be described below with reference to FIGS. 7 and 8.

The secondary battery 150 may include a pair of electrode tabs 111 that extend beyond a battery case 140. The pair of electrode tabs 111 may be connected to a pair of electrodes, respectively, including an anode tab 112 connected to an anode and a cathode tab 113 connected to a cathode.

The anode tab 112 and the cathode tab 113 may extend to an outside via a terrace portion 147a of the secondary battery 150. The terrace portion 147a may be a part of a sealing portion 147 at a boundary of the battery case 140 which may be formed somewhat wide such that the circuit board 200 may be mounted but is not limited thereto. Hereinafter, a portion where the pair of electrode tabs 111 are projected out the sealing portion 147 of the battery case 140 may be referred to as the terrace portion 147a.

The anode tab 112 and the cathode tab 113 may extend to an outside of the secondary battery 150 via the terrace portion 147a, be folded about 180 degrees and extend towards the secondary battery 150. A detailed coupling relationship between the anode tab 112 and the cathode tab 113 and the circuit board 200 will be described below.

The circuit board 200 may be electrically connected to the secondary battery 150. At least one device (or circuit) 250 may be mounted thereon. Referring to FIGS. 2 to 3, the circuit board 200 may include a bending portion (or intermediate portion) 220 and first and second substrate portions (or upper and lower portions) 210 and 230. The first and second substrate portions 210 and 230 extend from both ends of the bending portion 220, respectively. The first and second substrate portions 210 and 230 are spaced apart from, while overlapping, each other.

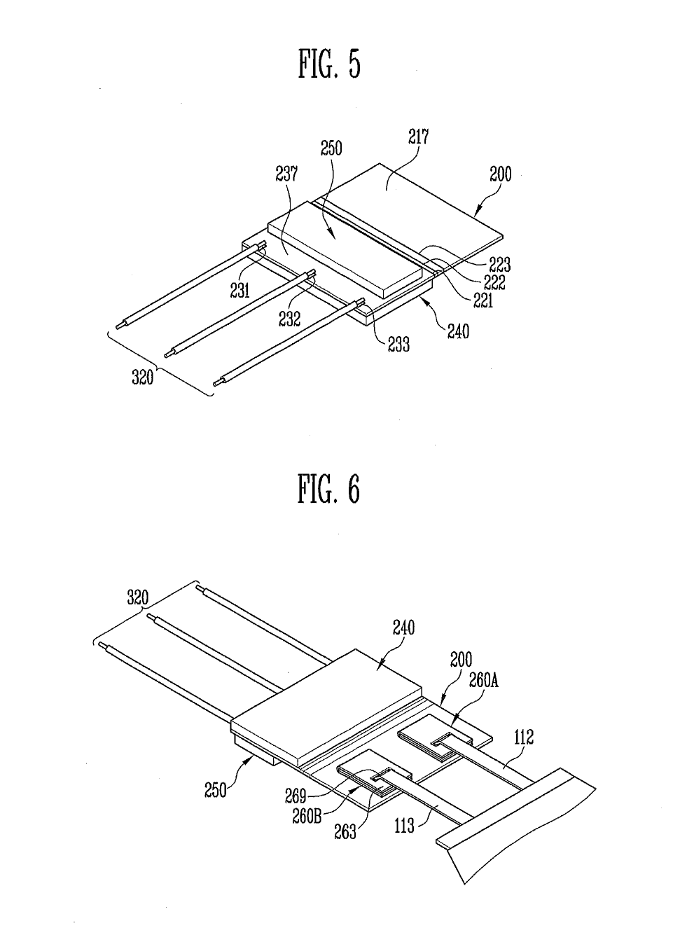

For convenience in illustration, the circuit board 200 before being connected to the secondary battery 150 is illustrated in FIGS. 4 and 5. FIG. 4 shows a state of the circuit board 200 before being bent. FIG. 4 is a perspective view illustrating the clip fixing surface on the top. FIG. 5 is a perspective view illustrating the device fixing surface of the circuit board 200 shown in FIG. 4 on the top. Referring to FIGS. 1 to 5, the circuit board 200 and components installed on the circuit board 20 will be described in detail below.

The circuit board 200 may be a circuit board that has a smaller width than a length in a width direction (hereinafter, the width direction refers to a direction that is substantially vertical to I-I line shown in FIG. 1) of the terrace portion 147a, that extends in a length direction (hereinafter, the length direction refers to a direction that is substantially parallel to the I-I line in FIG. 1), extending as it is bent once.

The circuit board 200 may include the first substrate portion 210 where the pair of electrode tabs 112 and 113 are fixed and the second substrate portion 230 where the at least one device 250 is fixed, the first and second substrate portions 210 and 230 being connected by the bending portion 220.

The first substrate portion 210 may be a substantially plate shaped member having a predetermined thickness. The first substrate portion 210 may include a clip fixing surface 215 and an opposing surface 217 of the clip fixing surface 215. The clip fixing surface 215 is a surface where the pair of electrode tabs 111 are fixed. There may be provided a pair of tab fixing clips 260 on the clip fixing surface 215 of the first substrate portion 210. The pair of tab fixing clips 260 may include an anode tab fixing clip 260A where the anode tab 112 is fixed and a cathode tab fixing clip 260B where the cathode tab 113 is fixed.

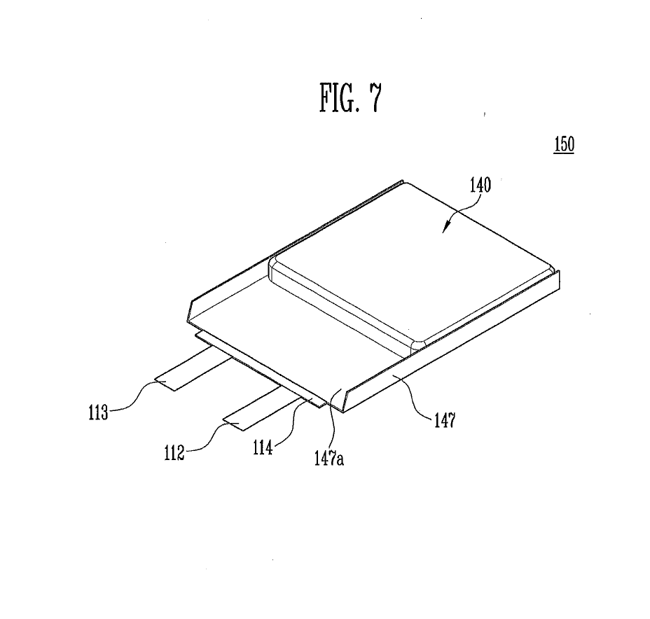

The pair of tab fixing clips 260 may be a conductive member, fixing each of the electrode tabs 112 and 113 by changing in shape due to an external force. The tab fixing clip 260 may be different in shape between when the tab fixing clip 260 is in a state in which it fixes the corresponding electrode tab and when the tab fixing clip 260 is in a state prior to the state in which it fixes the electrode tab. The tab fixing clip 260 shown in FIG. 4 is in the state in which the tab fixing clip 260 is in the state prior to the state in which it fixes the electrode tab. The tab fixing clip 260 shown in FIG. 6 is in the state in which it fixes the electrode tab.

With reference to FIG. 6, the tab fixing clip, being in the state in which it fixes the electrode tab, is described in detail. Holes 269 may be formed at a pair of tab fixing clips 260A and 260B. Through the holes 269, the anode and cathode tabs 112 and 113 may be inserted into an inside of the tab fixing clip 260 and fixed in the tab fixing clip 260.

With reference to FIGS. 4 and 6, the structure of the tab fixing clip 260 is described in further detail. The tab fixing clip 260 may include a first portion 261 fixed to the clip fixing surface 215 and a second portion 263 bending at the first portion 261 and extending above the first portion 261. The second portion 263 may fix the electrode tabs 112 and 113 inserted between the first portion 261 and the second portion 263 by pressurizing the electrode tabs 112 and 113. The first and second portions 261 and 263 may be a one body shaped like a plate and having the same width. For convenience in illustration, the bent portion that couples the first and second portions 261 and 263 is referred to as a clip bending portion 262.

The second portion 263 shown in FIG. 4 is before it fixes the electrode tab. The hole 264 may be bigger here than the hole for which the electrode tab is fixed. When the shape of the tab fixing clip 260 changes due to an external force, the bigger hole 264 in FIG. 4 changes in shape as the smaller hole 269 in FIG. 6. A cover portion 265 which partially covers the bigger hole 264 by being formed convexly upwards may be formed at the second portion 263 in FIG. 4. The cover portion 265 may change to be flat due to an external force, and the bigger hole 264 in FIG. 4 may change into the smaller hole 269 in FIG. 6.

With reference to FIGS. 3 and 6, the shape of the electrode tab fixed by the tab fixing clip 260 is described in detail. A pair of electrode tabs 112 and 113 fixed to the circuit board 200 by the tab fixing clip 260 may extend along an upper surface of the second portion 263, may further extend between the first and second portions 261 and 263 through the hole 269 and may be fixed.

The above described aspects may allow the pair of electrode tabs 111 to be fixed to the circuit board by 200 physically applying pressure rather than welding. Therefore, there may be no defect occurrence probability due to welding and coupling of the pair of electrode tabs to the circuit board may be made simple.

The pair of electrode tabs 112 and 113 may not only be firmly fixed by the tab fixing clip 260, but also may remain firmly connected to the circuit board 200 because the pair of electrode tabs 112 and 113 are bent once as they extend along the first substrate portion 210. The structure in which the pair of electrode tabs are bent as they extend along the first substrate portion 210 will be described below.

The second substrate portion 230 may be a substantially plate shaped member having substantially the same thickness as the first substrate portion, including a device fixing surface (or circuit fixing surface) 237 and an opposing surface 235 of the device fixing surface 237. The device fixing surface 237 is a surface where the at least one device 250 is fixed. There may be provided a plurality of wire coupling terminals 231, 232 and 233 on the device fixing surface 237. The wire coupling terminals 231, 232 and 233 may be a plurality of conductive pads.

The wire coupling terminals 231, 232 and 233 may be arranged in an area that remains after the at least one device 250 is mounted at the device fixing surface 237. In the drawings, it is illustrated as being provided on the boundary of the device fixing surface 237 but it is not limited thereto. If the at least one device is a plurality of devices and is arranged by being spaced apart from each other in the width direction, the plurality of wire coupling terminals may be arranged in empty spaces between the plurality of devices.

The bending portion 220 may be a portion formed by the circuit board 200 being folded about 180 degrees. The bending portion 220 may be a boundary that differentiates the first substrate portion 210 and the second substrate portion 230. Referring to FIG. 3, the bending portion 220 may be a curved surface, substantially U-shaped, a cross section in the length direction being convexly arranged towards the secondary battery 150. However, the shape of the bending portion 220 is not limited to the curved surface but may be folded about 180 degrees, forming one or two angled corners.

The circuit board 200 may be a flexible insulating substrate where conductive wires are laminated on both surfaces such that components may be mounted on the both surfaces of the circuit board 200. The circuit board 200 may be a conventional flexible printed circuit board.

With the above described structure, a device may be disposed compactly in a smaller space since the circuit board where a device, etc. is mounted is bent. Therefore, miniaturization and compactification may be possible.

The insulating plate 240 may be disposed between the first substrate portion 210 and the second substrate portion 230 and insulate between the first and second substrate portions 210 and 230. The insulating plate 240 may generally support the circuit board 200. The insulating plate 240 may be disposed between the clip fixing surface 215 of the first and second substrate portions 210 and 230 and may maintain a state in which the tab fixing clip fixes the pair of electrode tabs 111. However, the insulating plate 240 may, depending on a need, not be included.

The insulating plate 240 may be a substantially plate shaped member made of materials harder than the circuit board 200. The insulating plate 240 may be formed to have a thickness such that it is not bent. The insulating plate 240 may be a board generally having a rectangular shape as shown. However, the shape is not limited thereto, and may be of any shape which can support the circuit board.

In an embodiment, the insulating plate 240 may have an area that is substantially the same as, or greater than, an area of a region where the device is installed on the device fixing surface 237 and may be substantially the same as, or smaller than, an area of the device fixing surface 237. In another embodiment, the insulating plate 240 may have an area that is substantially the same as, or greater than, an area which a pair of electrode tabs 111, being spaced apart from each other, occupies, and may be the same as, or smaller than, an area of the clip fixing surface 215.

The insulating plate 240 may be fixed on the opposing surface 235 of the device fixing surface 237 and support the circuit board 200. The insulating plate 240 may be fixed on the opposing surface 235 of the device fixing surface 237 with an adhesive.

According to some embodiments, the device fixing surface 237 can be firmly supported by the insulating plate 240. Also, since the insulating plate 240 is provided between the first and second substrate portions 210 and 230 overlapping each other, the circuit board 200 that is bent can be firmly supported.

A plurality of wires 321, 322 and 323 may be welded to the wire coupling terminals 231, 232 and 233, respectively, electrically coupling the battery pack to an external device (now shown) to supply power from the battery pack to the external device or to supply power from the external device to the battery pack, via the wires 321-3230. As a result, the at least one device 250 may operate, or the secondary battery 150 may be charged. The at least one device 250 may operate as it receives the power supplied from the secondary battery 150. The wires 321-323 may be, unlike as shown in the drawings, of a harness type.

The at least one device 250 may be electrically connected to the secondary battery 150 via the circuit board 200, implementing a circuit that performs at least one of the predetermined control functions. The control function may include control relating to management of battery such as charge control, discharge control, overcharge control, overdischarge prevention control, other safety related control, sensor control, and communication control with an external device, for the secondary battery 150. The sensor may include temperature sensor, voltage sensor, current sensor and the like. Data for performing safety control can be collected via the sensor, for example measure temperature of a battery and the like can be measured by the temperature sensor.

In an embodiment of a circuit that performs control functions, the at least one device 250 may be at least a part of a protective circuit of the secondary battery. The protective circuit refers to a circuit capable of protecting a battery not only by controlling charge and discharge by controlling voltage or current of the secondary battery 150 but also by blocking overcharge, overdischarge, short circuit, inverse voltage and the like.

For example but without limitation thereto, in order to make up the protective circuit, the at least one device 250 may include at least one of a field effect transistor, an integrated circuit, a positive temperature coefficient, a switching device and the like, thereby controlling charge and discharge and blocking circuit.

The circuit board 200 with the at least one device 250, the plurality of wires 320 and the pair of tab fixing clips 260 may be a control module. The control module may be electrically connected to the secondary battery 150 to perform control relating to management of the secondary battery 150. Hereinafter, the control module may refer to a module including the circuit board 200, at least one device 250 mounted on the circuit board 200, the plurality of wires 320 and the pair of tab fixing clips 260 being connected to the circuit board 200.

Referring to FIGS. 2 and 3, the first substrate portion 210 and the second substrate portion 230 overlap each other while being spaced apart from each other. The first substrate portion 210 may be arranged such that the clip fixing surface 215 face the second substrate portion 230. The second substrate portion 230 may be arranged such that the opposing surface 235 of the device fixing surface 237 face the clip fixing surface 215. On the opposing surface 235 of the device fixing surface 237, the insulating plate 240 may be fixed, such that the clip fixing surface 215 of the first substrate portion 210 may face the insulating plate 240.

The pair of electrode tabs 111 may be projected out and extend from the terrace portion 147a. The pair of electrode tabs 111 may extend along the first substrate portion 210, extending to an outer side of the secondary battery 150 on the opposing surface 217 of the clip fixing surface 215, bending in an opposite direction, and extending towards the secondary battery 150 on the clip fixing surface 215. The pair of electrode tabs 111 may be fixed to the pair of tab fixing clips 260, respectively, on the clip fixing surface 215. As described above, as the tab fixing clip 260 changes shape due to an external force, the tab fixing clip may fix the electrode tabs 111, and no welding may be required.

A first insulating tape 370 may be adhered to the pair of electrode tabs 111, thereby insulating the electrode tabs 111 from a periphery. The first insulating tape 370 may be attached to cover the substantial entirety of the pair of electrode tabs between the insulating plate 240 and the pair of electrode tabs 111. The pair of electrode tabs 111 may pass the bent area and extend to the terrace portion 147a.

A second insulating tape 360 may be further attached to the circuit board 200, insulating the circuit board 200 and the components mounted on the board 200 from the periphery. The second insulating tape 360 may be attached to cover the substantial entirety of each of the device fixing surface 237 of the second substrate portion, the opposing surface 217 of the clip fixing surface and the bending portion 220 therebetween.

FIGS. 7 and 8 illustrate a secondary battery 150 according to one embodiment, schematically illustrating an electrode assembly that is sealed in a pouch type case. The secondary battery 150 may include a battery case 140 and an electrode assembly 110 that is sealed together with an electrolyte in the battery case.

Referring to FIG. 8, the electrode assembly 110 may be formed by stacking an anode plate, a separating plate and a cathode plate sequentially, and thereafter winding them. The anode plate may function as an anode, and the cathode plate may function as a cathode. The electrode assembly 10 may include a pair of electrode tabs 111 that extend to an outside of the battery case. The pair of electrode tabs 111 may include an anode tab 112 that is electrically connected to the anode tab 112 and cathode tab 113 that is electrically connected to the cathode plate. However, the anode tab 112 and the cathode tab 113 may be switched in terms of position. Electrochemical energy generated by the secondary battery may be transferred to an outside by the pair of electrode tabs 111.

The battery case 140 may be a member that surrounds the electrode assembly 110. The battery case 140 may include a first portion case 141 and a second portion case 142. A space for receiving the electrode assembly 110 may be formed in the first portion case 141. The second portion case 142 may cover the first portion case 141. The space for receiving the electrode assembly 110 may correspond to a shape and a size of the electrode assembly 110. For example, but without limitation thereto, the space for receiving the electrode assembly 110 may be made by a deep drawing process which is used for manufacturing a seamless hollow container on a flat board.

The secondary battery 150 may be manufactured by providing the electrode assembly 110 and the electrolyte in the space for receiving the electrode assembly 110 and by forming a sealing portion 147 by thermal bonding edges 148 of the first portion case 141 and edges 146 of the second portion case 142 in a state where the first portion case 141 and the second portion case 142 are in close contact with each other. The electrode tabs 111 of the electrode assembly 110 may extend to the outside of the battery case through the sealing portion 147.

Referring to FIG. 8, the battery case 140 may include an inner resin layer 143, a metal layer 144 and an outer resin layer 145, sequentially. The inner resin layer 143 may directly face the electrode assembly 110. The outer resin layer 145 may correspond to an outermost surface of the battery case 140. The inner resin layer 143 and the outer resin layer 145 may be formed of a polymer resin, etc., which is an electrically non-conductor, in order to prevent short circuit and the like. The metal layer 144 may be provided between the inner resin layer 143 and the outer resin layer 145. The metal layer 144 may provide a predetermined mechanical strength to the battery case 140, and may include, for example but without limitation thereto, aluminum and the like.

The pair of electrode tabs 111 may further include a film 114 for insulation. The film 114 may insulate between the pair of electrode tabs 111 and the battery case 140. The film 114 may be safely mounted at the sealing portion 147. The film 114 may be made of an electrically non-conductor and prevent short circuit of the pair of electrode tabs 111 and the metal layer 144. The film 144 may be formed of a similar material as the sealing portion 147. As a result, the sealing portion 147 may be thermally bonded completely. The electrode tabs 111 formed of a metal by the film may closely contact the sealing portion 147 completely, strengthening sealing force of the battery case 140. The film 114 may be bent along the curved surface of the electrode tabs 111.

It has been described in detail that the electrode assembly of winding type is sealed in a pouch type case as an embodiment of the secondary battery with reference to FIGS. 7 and 8. However, the present invention is not limited thereto. A stack type electrode assembly may be sealed in a pouch type case or a stack or winding type electrode assembly may be sealed in an angular case.

Though not illustrated, a battery pack in FIG. 1 may further include a third insulating tape that overall surrounds a control module and the terrace portion 147a where the control module is mounted but such that the plurality of wires 320 are exposed. The battery pack as shown in FIG. 1 may further include a label attached to an outer surface of the battery case 140.

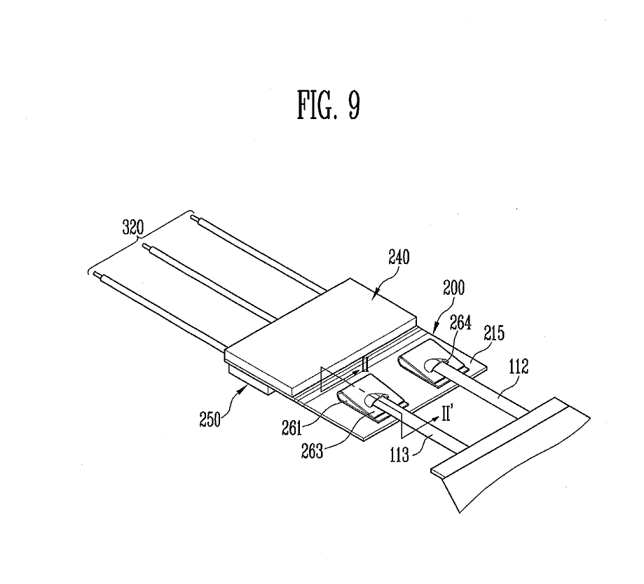

Hereinafter, an embodiment of a manufacturing method of the battery pack is described with reference to FIGS. 1 to 12. Referring to FIGS. 9 and 10, the anode tab 112 and the cathode tab 113 may be inserted into the holes 264 of the pair of tab fixing clips, respectively, of the control module before they change shape. Referring to FIG. 10, an external force acts upon in a direction of the arrow in a state in which the anode tab and the cathode tab are inserted into the tab fixing clip, changing the cover portion 265. The cover portion 265 may be hammered by the flat portion of a hammer. The changed cover portion 265 may be changed to be flat as shown in FIG. 6. The holes 264 in FIG. 10 may change to the holes 269 in FIG. 6. The pair of electrode tabs 111 may be fixed to the tab fixing clip 260.

A first insulating tape 370 may be attached to a pair of electrode tabs 111 connected to the control module as the shape in FIG. 6. Though not illustrated, the first insulating tape 370 may be attached to cover not only the pair of electrode tabs 111 but also the clip fixing surface 215, the film 114 and the terrace portion 147a, partially or completely.

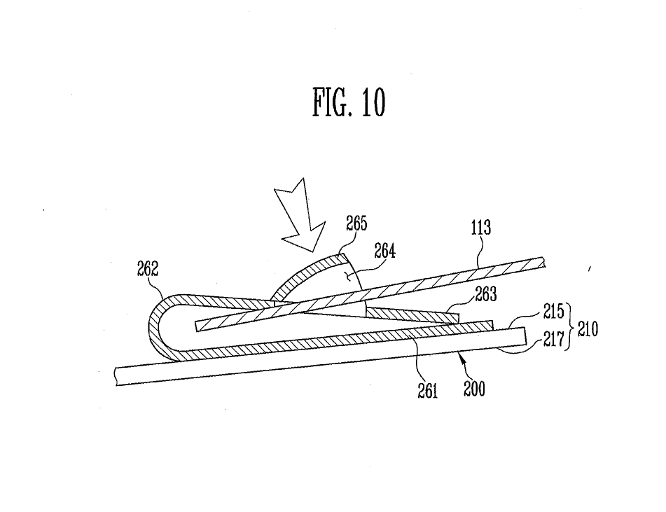

The control module where the first insulating tape 370 is attached to the pair of electrode tabs 111 and the periphery may be folded about 180 degrees in a direction of arrow 1 shown in FIG. 11 along a plurality of guide lines 221, 222 and 223 shown in FIG. 5. The circuit board 200 folded in the direction of arrow 1 in FIG. 11 may include a bending portion 220.

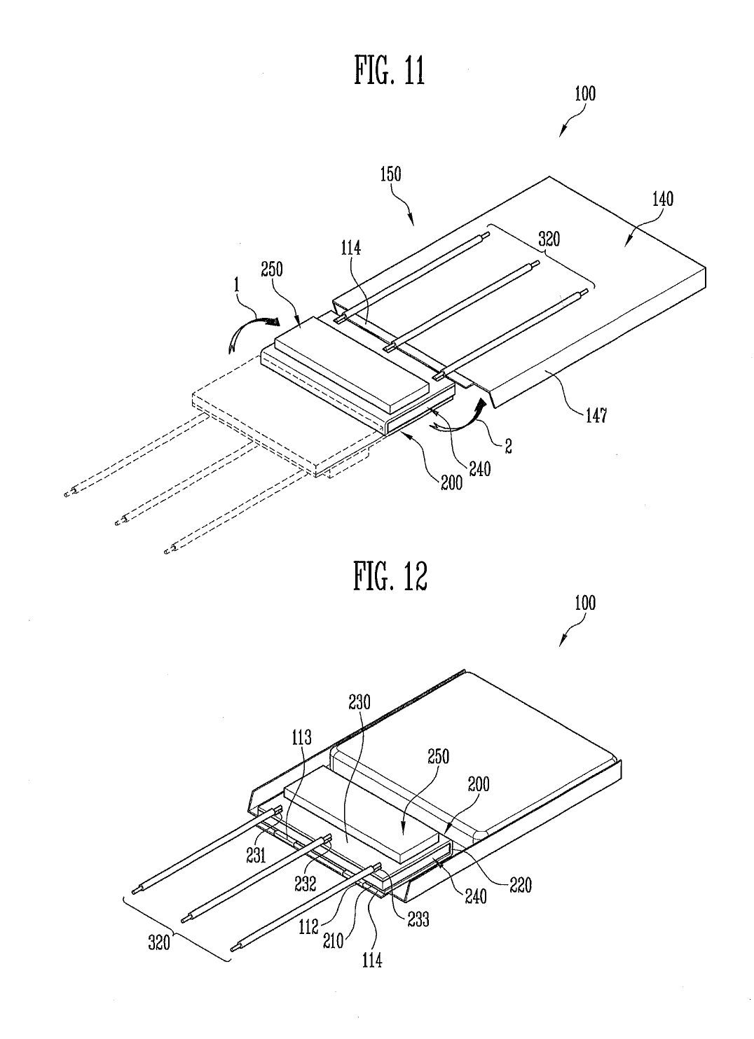

A second insulating tape 360 may be attached to the control module that is folded in the direction of arrow 1 in FIG. 11. Though not illustrated, the second insulating tape 360 may be attached to cover substantially an entirety of each of the device fixing surface 237, the bending portion 220 of the same surface as the device fixing surface 237 and the opposing surface 215 of the clip fixing surface 215. The second insulating tape 360 may be understood to cover substantially an entirety of each of the device fixing surface 237, the opposing surface 217 of the tab fixing surface and the bending portion 220 therebetween in the circuit board 200 shown in FIG. 5. However, the first and second insulating tapes 370 and 360 being attached as such is omitted from FIGS. 11 to 12.

The control module where both of the first insulating tape 370 and the second insulating tape 360 are attached may be mounted at the terrace portion 147a as shown in FIG. 12 by a pair of electrode tabs 111 being folded in a direction of arrow 2 in FIG. 11. The opposing surface 217 of the clip fixing surface 215 may be mounted to face the terrace portion 147a and may be the battery pack as shown in FIG. 3.

Though not illustrated, a third insulating tape may be further attached to the battery pack in FIG. 12 to surround substantially an entirety of each of the control module and the terrace portion. A label may be further attached to the case 140 of the secondary battery.

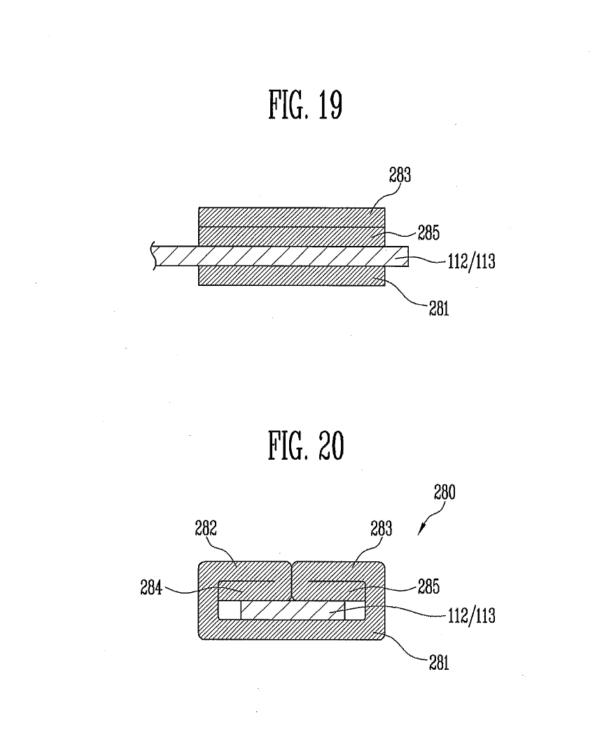

The tab fixing clip 260 may change in shape in a variety of ways. Hereinafter, a battery pack to which modified embodiment of the tab fixing clip is applied will be described with reference to FIGS. 13 to 20. Above-described embodiment and constitution are referred to by same reference numerals, and detailed description thereof will be omitted.

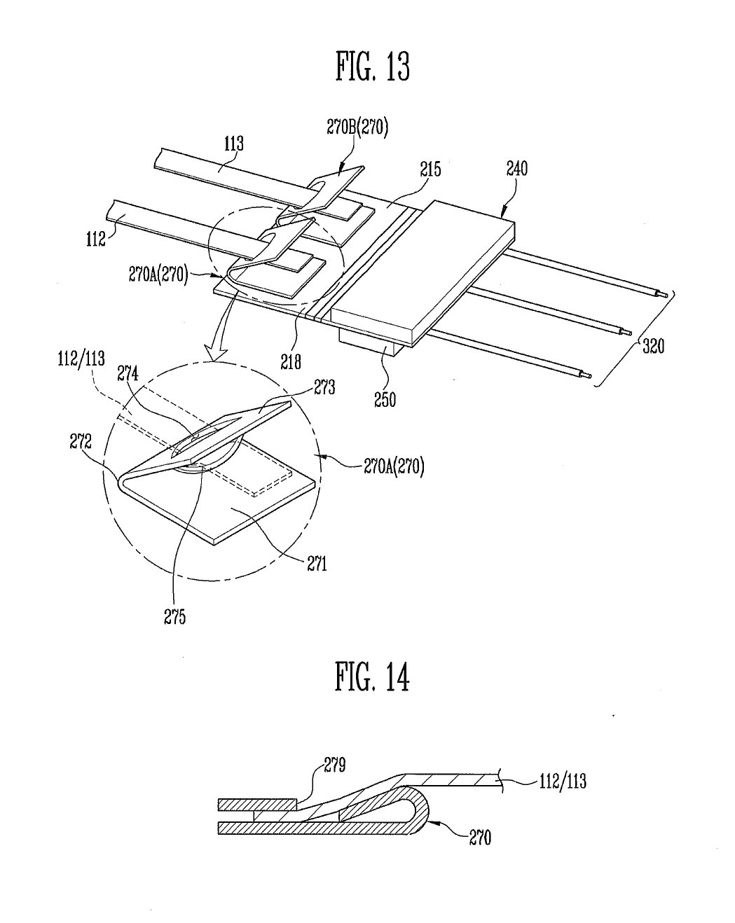

With reference to FIGS. 13 and 14, another embodiment of the tab fixing clip 260 will be described in detail. The tab fixing clip 270 may include a cover portion 275 formed convexly towards a first portion 271. The tab fixing clip 270 of the embodiment of FIG. 13 may include the first portion 271 that is fixed to a tab fixing surface 215 and a second portion 273 extending and being bent at the first portion 271. A bending portion 272 may couple the first and second portions 271 and 273. Holes 274 into which a pair of electrode tabs are respectively inserted may be formed at the second portion 273. A cover portion 275 that partially covers the holes 274 may be formed convexly towards the first portion.

The tab fixing clip 270 as shown in FIG. 13 is before the electrode tab is fixed. The electrode tab may be inserted through the holes 274 of the second portion formed. The tab fixing clip 270 of FIG. 13 where the electrode tabs 112 and 113 are inserted respectively may be, similar to the arrow shown in FIG. 10, changed in shape as an external force acts upon towards an upper surface of the second portion. As shown in FIG. 14, the first portion 271 and the second portion 273 may be parallel to each other, fixing the electrode tabs 112 and 113. As a boundary of the cover portion 275 of the tab fixing clip 270 and size of a space surrounded by the holes 274 of the second portion change in size, smaller holes 279 may be formed.

Although in an embodiment, the holes 274 formed on a surface of the second portion 273 when viewed from an outer surface of the second portion 273 may not change in size, the shape of the holes 279 that are located between the first portion and the second portion, that are surrounded by the boundary of the cover portion 275 and the holes 274 of the second portion and which the electrode tabs 112 and 113 pass through may change in shape.

In the tab fixing clip 270 in an embodiment in FIG. 13, the bending portion 272 may be arranged in an opposite way from the arrangement of the tab fixing clip in FIG. 4. In the tab fixing clip 260 in the embodiment shown in FIG. 4, the bending portion 262 may be adjacently arranged to the bending portion 220 of the circuit board. However, in the tab fixing clip 270 in an embodiment shown in FIG. 13, the bending portion 272 may be located on an opposite side of the bending portion 220 of the circuit board. All others may be the same as the above-described embodiment and thus detailed description will be omitted.

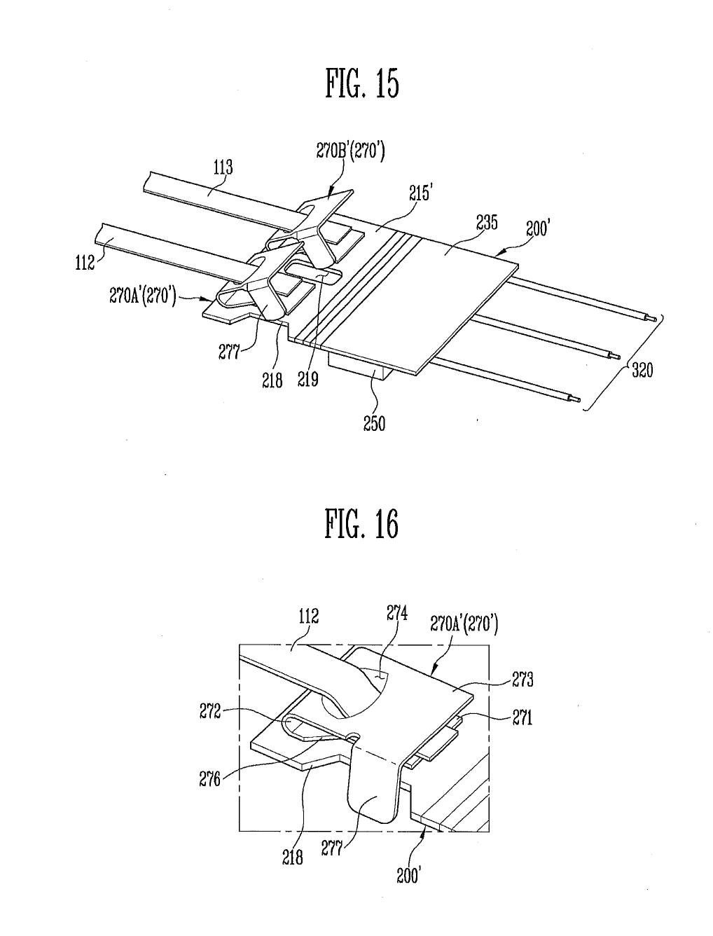

With reference to FIGS. 15 to 17, yet another embodiment of the tab fixing clip will be described in detail. A tab fixing clip 270′ may further include a clip wing 277 at the fixing clip 270 in the embodiment shown in FIG. 13. The clip wing 277 may be bent and further extended from a side boundary of the second portion 273 towards the circuit board.

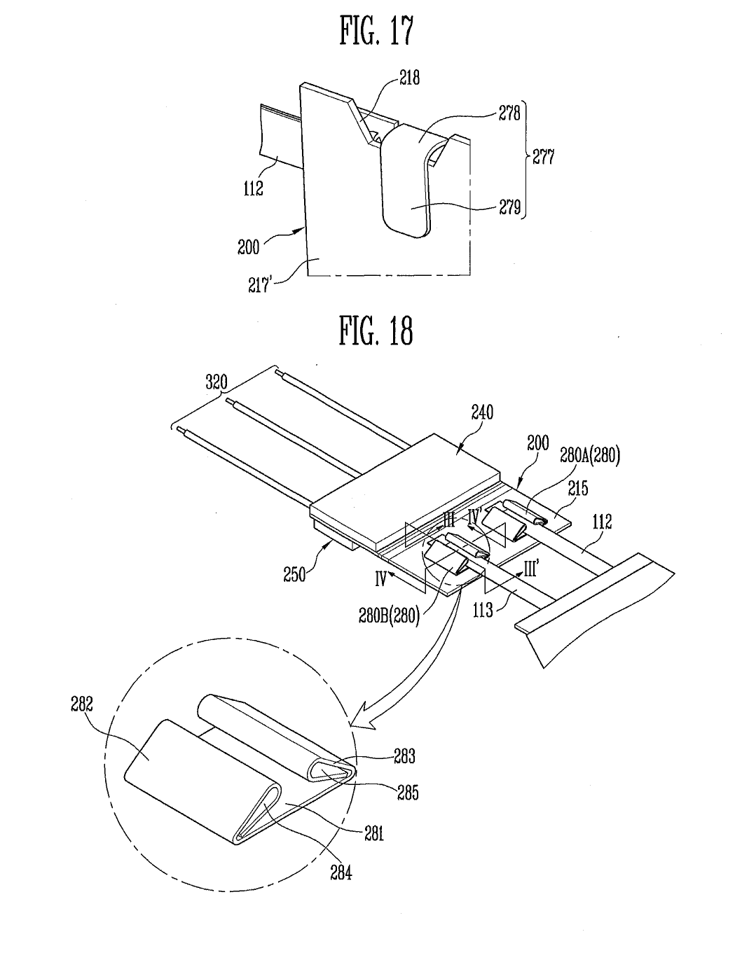

The clip wing 277 shown in FIGS. 15 and 16 is before it is fixed to the circuit board. The clip wing shown in FIG. 17 is fixed to the circuit board by being bent. Fixed clip wing may include a wing bending portion 278 surrounding a boundary of a circuit board and a wing fixing portion 279 bent at the wing bending portion 278 and extending along an opposing surface 217′ of the clip fixing surface of the circuit board.

The clip wing 277 may be adjacently arranged to the boundary of the electrode tab to more firmly fix the electrode tabs 112 and 113. Incision portions 218 and 219 that pass through the clip wing 277 may be provided at the first substrate portion of the circuit board 200′. A groove 276 may be provided at a location corresponding to the incision portions 218 and 219 at the first portion 271. Therefore, even when the tab fixing clip 270′ is fixed towards an inner side, being spaced apart, from the boundary of the first substrate portion, the clip wing may pass through the incision portions 218 and 219 and the groove 276. Therefore, as shown in FIG. 17, the wing bending portion 278 may be provided at a location more adjacent to the electrode tab.

The clip wing 277 may, as shown in FIG. 17 surround the boundary of the incision portion 218 and extend to an opposite side of the first portion 271 of the tab fixing clip to fix such that the first portion 271 and the second portion 273 of the tab fixing clip are not spaced apart from each other. The wing bending portion 278 may surround the boundary of the incision portion 218, and the wing fixing portion 279 that extends along the opposite surface 217′ of the clip fixing surface which is bent at an end of the wing bending portion 278 may be located on an opposite side of the first portion 271.

The tab fixing clip 270′ in FIG. 15 may change in shape in the same manner as FIG. 14 due to an external force to have the shape of the tab fixing clip in FIG. 16. As the clip wing 277 is bent, the wing bending portion 278 and the wing fixing portion 279 may be formed, finally being fixed as shown in FIG. 17.

With reference to FIGS. 18 to 20, yet another embodiment of the tab fixing clip may be described in detail. The tab fixing clip 280 may include a first portion 291 and second portion. The first portion 291 may be fixed to the clip fixing surface 215. The second portion may be a pair of members bent at both boundaries of the first portion, respectively, extend toward each other and extend toward a clip bending portion connected to the first portion by folding inwardly. With reference to FIG. 18, before the pair of electrode tabs are fixed to the tab fixing clip 280, the second portion may be spaced apart from the first portion, and the pair of members of the second portion may be spaced apart from each other as well.

Each of the pair of members of second portions may include upper portions 282 and 283 extending, being bent at both boundaries of the first portion 281 and lower portion 284 and 285 extending towards the boundary between the upper portions and the first portion, being bent at the upper portions. The pair of electrode tabs 112 and 113 may be inserted between the first portion 281 and the lower portions 284 and 285 of the second portion.

As the upper portions 282 and 283 of the second portion change in shape due to an external force, a gap between the upper portions becomes narrow, and the upper portions of the second portion and the lower portions of the second portion change in shape in parallel with the first portion. As a result, the pair of electrode tabs 112 and 113 may be fixed. That is, when the tab fixing clip 280 fixes the pair of electrode tabs, the pair of electrode tabs 112 and 113 are inserted between the first portion and the second portion, and the first portion and the second portion are parallel to each other.

Although it is illustrated in FIG. 20 as though there is no gap in between the pair of members of the second portion, it is for illustration purposes only and the shape of the tab fixing clip 280 fixing the pair of electrode tabs is not limited thereto. The tab fixing clip 280 in an embodiment as shown in FIG. 18 fixes the pair of electrode tabs as the gap or hole between the pair of members of the second portion changes in shape. As illustrated in the above-described embodiments, as the shape formed at the second portion of the tab fixing clip changes in shape, the electrode tabs are fixed by being pressured.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack comprising:
a secondary battery including at least a pair of electrode tabs;
a circuit board accommodating at least one circuit configured to control at least one of charging and discharging operations of the secondary battery; and
at least a pair of tab fixing clips placed at the circuit board and configured to fix each of the electrode tabs,
wherein each tab fixing clip includes:
a bending portion including first and second ends opposing each other; and
first and second portions respectively extending from the first and second ends of the bending portion and at least partially overlapping each other in the depth dimension of the secondary battery, wherein the bending portion is bent with respect to at least one of the first and second portions, and wherein at least part of the corresponding electrode tab is interposed between and contacted by the first and second portions.

2. The battery pack as claimed in claim 1, wherein the second portion is configured to fix the electrode tab based on pressure applied thereto.

3. The battery pack as claimed in claim 1, wherein each of the tab fixing clips further comprises a clip wing extending toward the circuit board from the second portion, being bent and being fixed to the circuit board.

4. The battery pack as claimed in claim 3, wherein the clip wing extends to an opposite surface of a surface of the circuit board to which the second portion is fixed.

5. The battery pack as claimed in claim 3, wherein the circuit board has an incision portion formed therein through which the clip wing passes.

6. The battery pack as claimed in claim 5, wherein the incision portion is formed adjacent to a boundary of the first portion.

7. The battery pack as claimed in claim 5, wherein the first portion includes a groove at a location corresponding to the incision portion.

8. The battery pack as claimed in claim 1, wherein the circuit board includes a clip fixing surface on which the tab fixing clips are fixed,
wherein the electrode tabs extend towards an outer side of the secondary battery at an opposing surface of the clip fixing surface and extend towards the secondary battery at the clip fixing surface.

9. The battery pack as claimed in claim 8, wherein the circuit board is bent such that a pair of inner surfaces face each other, and wherein the clip fixing surface is one of the pair of inner surfaces.

10. The battery pack as claimed in claim 9, further comprising an insulating substrate interposed between the pair of inner surfaces and supporting the circuit board.

11. The battery pack as claimed in claim 1, wherein the second portion has a hole.

12. The battery pack as claimed in claim 11, wherein each electrode tab includes an inserted portion that is inserted into the hole and interposed between and contacted by the first and second portions.

13. The battery pack as claimed in claim 12, wherein each electrode tab includes a non-inserted portion that is not inserted into the hole and contacts the second portion.

14. The battery pack as claimed in claim 13, wherein the non-inserted portion non-linearly extends from the inserted portion.

15. The battery pack as claimed in claim 1, wherein the electrode tabs are inserted into a gap between the first portion and the second portion.

16. The battery pack as claimed in claim 1, wherein the second portion is configured to press the corresponding electrode tab against the first portion.

17. A battery pack comprising:
a secondary battery including at least a pair of electrode tabs;
a circuit board accommodating at least one circuit configured to control at least one of charging and discharging operations of the secondary battery; and
at least a pair of tab fixing clips placed at the circuit board and fixing each of the electrode tabs,
wherein each tab fixing clip includes:
an intermediate portion including first and second ends opposing each other;
upper and lower portions respectively extending from the first and second ends of the intermediate portion and at least partially overlapping each other in the depth dimension of the secondary battery, wherein the upper portion has a hole into which at least part of the corresponding electrode tab is inserted, interposed between and contacted by the first and second portions.

18. The battery pack as claimed in claim 17, wherein each electrode tab includes a non-inserted portion that is not inserted into the hole and contacts the upper portion.

19. The battery pack as claimed in claim 18, wherein the non-inserted portion non-linearly extends from the inserted portion of the electrode tab.

20. The battery pack as claimed in claim 17, wherein the upper portion is configured to fix the electrode tab based on pressure applied thereto.
